(19) United States
(12) Patent Application Publication
(10) Pub. No.: US 2016/0036860 A1
(43) Pub. Date: Feb. 4, 2016

(54) POLICY BASED DATA PROCESSING

(71) Applicant: TELEFONAKTIEBOLAGET L M ERICSSON (PUBL), Stockholm (SE)

(72) Inventors: Bo XING, Fremont, CA (US); Christian SCHAEFER, Solna (SE)

(73) Assignee: TELEFONAKTIEBOLAGET L M ERICSSON (PUBL), Stockholm (SE)

(21) Appl. No.: 14/776,099

(22) PCT Filed: Mar. 14, 2014
(86) PCT No.: PCT/SE2014/050315

§ 371 Date: Sep. 14, 2015

Related U.S. Application Data
(60) Provisional application No. 61/790,798, filed on Mar. 15, 2013.

(51) Int. Cl. H04L 29/06; G06F 17/30

(52) U.S. Cl. CPC H04L 63/20; H04L 63/105; G06F 17/30589

(57) ABSTRACT

A method and system for protecting resources stored in a data store, wherein the different resources are protectable on the basis of different policies defined for each of the respective resources and structured in a hierarchical manner. The method allows the different resources to be protected with a variable granularity, by defining policies such that the most fine-grained of the policies defined for a specific resource is dynamically applicable for that resource when executing a request involving that resource.

### TECHNICAL FIELD

The present disclosure relates to a method for providing policy based data protection and a system capable of executing such a method.

### BACKGROUND

Today, we are in an era of data explosion. In particular there is an explosion of personal data, where a large amount of data is being continuously generated by individuals as well as services and devices are also capable of working on behalf of individuals. These data, when aggregated, processed and minded, capture our profiles, preferences, behaviors, and much more. This is a great foundation for the creation of personalized services and the resulting monetization opportunities. Unfortunately users, as the nominal owners of the data, do not have full control of how their data is shared and used, nor do they get much out of the monetization of their data being used. One of the reasons for this is that the ownership of the data is often logical rather than physical.

A suitable policy language can be used to describe, in a generic way, how resources, such as e.g. files, Web pages, images or videos, are to be treated by network nodes exchanging data in a communication network. In a Representation State Transfer (REST) framework, a resource is often represented as a REST endpoint URL. This type of policy usually describes a resource to be protected by referring to an instance of this resource. Additionally, a requester, or some attributes of a requester, need to be known to be able to choose the correct policy. Within a policy, rules usually specify conditions for how to access a certain resource. Such a rule may e.g. be specified as “App A can read my location data only between 9 am and 5 pm on weekdays”. These types of policy languages typically use different formats, such as e.g. Extensible Markup Language (XML), to describe a specific policy. Additionally, such a language may vary in the expressivity of what should be enforced.

By way of example, eXtensive Access Control Markup Language (XACML) is one instance of a policy language specified within the Advancing Open Standards for the Information Society (OASIS) standard using XML to describe rules for accessing resources. XACML also describes an access control decision request/response language using XML which allows forming of a query to ask whether or not a given action should be allowed and to interpret the result accordingly. Additionally XACML provides for the ability to find a policy that applies to a given request and to evaluate a request against that policy.

In an XACML usage scenario it may be assumed that an individual or an application need to take an action by involving a resource, where this resource, which may be provided e.g. from a file system or a Web server, is protected by a Policy Enforcement Point (PEP). The PEP will form a request based on one or more attributes associated with a requester; the resource in question, the requested action, and possibly any further information which may pertain to the request. The PEP will then send this request to a Policy Decision Point (PDP), which will consider the request and a policy that applies to the request, and come up with an answer about whether or not access should be granted. The answer to the request is returned to the PEP, which can then allow or deny the requester access to the resource.

Data stores are available in several different variations, e.g. in the form of a database, such as e.g. a relational database, a not only Structured Query Language (NoSQL) database, or a graph database; a file system, such as e.g. Unix, Windows file system or a distributed file system, such as e.g. Hadoop Distributed File System (HDFS) or in the form of documents, such as e.g. a collection of comma separated value (csv) files. An instance of a data store may thus be any of a database, a file system or a number of documents. Different classes of databases store data with different data units. In relational and NoSQL databases, the smallest data unit that is identifiable is a row, whereas in graph databases the smallest identifiable data unit is instead a node or an edge, while in a file system of a collection of documents, the smallest identifiable data unit could instead be a file or a line in a file, respectively. Existing solutions to protect data in data stores is typically coarse-grained, where a requester has either full access to all data of a data owner, or he has no access to any data of the data owner, and this control rule is statically predefined.

### SUMMARY

It is an object of the present document to address, at least some of the problems discussed above by suggesting a method which enables a user to flexibly define policies, to search resources applying the defined policies, as well as to amend and/or delete defined policies in an efficient way.

According to one aspect a method for protecting resources stored in a data store is provided, wherein the different resources are protectable on the basis of different policies defined for each of the respective resources and structured in an hierarchical manner, thereby allowing the different resources to be protected with a variable granularity, by defining policies such that the most fine-grained of the policies defined for a specific resource is dynamically applicable for that resource when executing a request involving that resource.

More specifically, policies may be defined by defining a first policy for a class representing at least one data item, such that the first policy is applied for said class and each subclasses of said class for which no policy has been defined, wherein for each of said subclasses for which a policy other than the first policy has been defined, such a policy overrides said first policy when executing a request involving at least one of the sub-classes.

Defining a policy to be applied for at least one data item represented by a class can be executed by associating a policy with a unique identity or name, where each unique identity or name identifies one of said data items or said class, thereby making the policy identifiable.

According to one embodiment, a policy, which may be a policy other than the first policy, can be defined for each sub-class comprising at least one data item and being a subclass of said class for which no policy has previously been defined, by replicating the content of said first policy to each of said other policies.

According to another embodiment, a policy, can instead be defined by defining a policy, which may be a policy other than the first policy, for each sub-class comprising at least one data item and being a subclass of said class for which no policy has previously been defined, by providing, to the respective policy for each of said subclasses, a reference, referring to said first policy.

According to yet another embodiment, a policy can instead be defined by defining a policy, which may be a policy other than the first policy, by listing each sub-class comprising at least one data item and being a subclass of said class, for which no policy has previously been defined, as a resource for which said first policy is to be applied.

According to another aspect a method for searching for resources for which a policy has been defined according to any of the embodiments mentioned above is suggested, wherein the searching is executed by: identifying a query received from a requester; identifying requested data items; determining data items that are accessible to the requester according to relevant policies by matching, for each identified data item, a unique Identity or name associated to a specific policy to stored policies, and providing a response to the requester according to the matching policies.

According to another aspect, a method for updating a first policy which has been defined for a class representing at least one data item according to any of the embodiments suggested above, is suggested, wherein, in addition to updating the first policy defined for a class representing said data items, the method also comprising: updating each policy defined for a subclass of said class having the same content as the first policy.

According to another aspect, a method for deleting a first policy which has been defined for a class representing at least one data item according to any of the embodiments suggested above, is suggested, wherein, in addition to deleting the first policy defined for said data items, the method also comprising: deleting each policy defined for a subclass of said class having the same content as the first policy.

According to another aspect a computer program, comprising instructions which when executed on at least one processor causes the at least one processor to carry out the method according to any of the methods suggested above, is suggested.

According to another aspect, a system capable of protecting resources stored in a data store is provided, which comprise at least one processor and at least one memory comprising instructions which when executed by the at least one processor causes the system to protect the different resources on the basis of a policy defined for each of the respective resources and structured in an hierarchical manner, thereby allowing the different resources to be protected with a variable granularity, by defining policies such that the most fine-grained of the policies defined for a specific resource is dynamically applicable for that resource when executing a request involving that resource.

The suggested system typically comprise further instructions, which when executed by the at least one processor causes the system to: define a first policy for data items of a resource represented by a class, such that the first policy is applied for each data item represented by said class and each data item represented by that resources subclasses for which no policy has been defined, wherein for each data item represented by any of said subclasses for which a policy other than the first policy has been defined, such a policy overrides said first policy when executing a request involving at least one of the data items.

The suggested system typically also comprise further instructions, which when executed by the at least one processor causes the system to: define a policy to be applied for a class by associating said policy with a unique identity or name, where each unique identity or name identifies one of said data items or said class, thereby making the policy identifiable to the system.

According to one embodiment, the system suggested above comprise further instructions, which when executed by the at least one processor causes the system to define a policy for each class comprising at least one data item and being a subclass of said class for which no policy has previously been defined, by replicating the content of said first policy to each of said other policies.

According to yet another embodiment, the system comprise further instructions, which when executed by the at least one processor causes the system to define a policy, which may be a policy other than the first policy, for each sub-class comprising at least one data item and being a subclass of said class for which no policy has previously been defined, by providing, to the respective policy for each of said subclasses, a reference, referring to said first policy.

According to another embodiment, the system comprise further instructions, which when executed by the at least one processor causes the system to define a policy, which may be a policy other than the first policy, by listing each sub-class comprising at least one data item and being a subclass of said class, for which no policy has previously been defined, as a sub-class for which said first policy is to be applied.

According to another aspect, the system comprises further instructions, which when executed by the at least one processor causes the system to search for resources for which a policy has been defined, by: identifying a query received from a requester; identifying requested data items; determining data items that are accessible to the requester according to relevant policies by matching, for each identified data item, a unique Identity or name associated to a specific policy to stored policies, and providing a response to the requester according to the matching policies.

The suggested system typically also comprise further instructions, which when executed by the at least one processor causes the system to update a first policy and to update each policy defined for a subclass of said class having the same content as the first policy and in a similar manner the system may comprise further instructions, which when executed by the at least one processor causes the system to delete a first policy which has been defined for at least one data item represented by a class and to delete each policy defined for a subclass of said class having the same content as the first policy.

### BRIEF DESCRIPTION OF THE DRAWINGS

Embodiments will now be described in more detail in relation to the accompanying drawings, in which:

FIG. 1 is a schematic illustration of a system of a system comprising a PDV and a PPM.

FIG. 2 is a more detailed illustration of the PPM of FIG. 1.

FIG. 3 is an illustration of a system comprising a plurality of PDVs and PPMs.

FIG. 4 is a more detailed illustration of the PPM of FIG. 2.

FIG. 5 is another more detailed illustration of the PPM of FIG. 2.

FIG. 6 is an illustration of a method for defining policies according to one embodiment.

FIG. 7 is an illustration of a resource tag for identifying policies which has been defined for a resource.

FIG. 8 is an illustration of a method for defining policies according to a first embodiment.

FIG. 9 is an illustration of a method for defining policies according to a second embodiment.

FIG. 10 is an illustration of a method for defining policies according to a third embodiment.

FIG. 11a-c are illustrations of a method for handling a request or inquiry according to one embodiment.

FIG. 12 is an illustration of a data storage arranged as a PDV according to one embodiment.

FIG. 13 is an illustration of a PPM according to one embodiment.

FIG. 14 is an illustration of a method for defining policies according to the embodiment illustrated in FIG. 6.

FIG. 15a is an illustration of a method for defining policies according to the embodiment illustrated in FIG. 8.

FIG. 15b is an illustration of a method for defining policies according to the embodiment illustrated in FIG. 9.

FIG. 15c is an illustration of a method for defining policies according to the embodiment illustrated in FIG. 10.

FIG. 16 is an illustration of a method for handling a search query according to one embodiment.

FIG. 17 is an illustration of a method for handling a updating request according to one embodiment.

FIG. 17 is an illustration of a method for handling a deletion request according to one embodiment.

FIG. 19 is an illustration of a system comprising at least one data store and at least one PPM according to one embodiment.

FIG. 20 is an illustration of the system of FIG. 19 according to one embodiment.

### DETAILED DESCRIPTION

Recently there has been a strong momentum on a move towards a Personal Data ecosystem. It is to advocate giving back users' data to them and having them in the center of the loop in controlling what data is to be shared and how. What is envisioned is a fully distributed architecture, where data owners, from hereinafter referred to as owners, such as e.g. individuals, organizations, enterprises, or governments, each has his/her/its own standalone data store, securely holding all data that could be shared with the data requesters, but need delicate protection when being shared. Applications, which from hereinafter may also be referred to as services or Apps, may be developed in the Personal Data ecosystem read/write user data from/to respective data stores, with the data owners' authorizations. Cross-application sharing (an application reads data written by another application) is typically made easier, enhancing the level of personalization that every application could make.

The notion of a data stores poses an array of research challenges. On the top of the list are (1) data representation—how to represent data in a data store in a natural, meaningful and easy-to-mine way, (2) data access API—how to allow applications to have rich and flexible interactions with the data inside data stores, (3) data access control—how to enable data owners to have dynamic, variable-grained, and context-aware control of how the data in their data stores is accessed by applications. According to one embodiment, the data representation is addressed by using a graph-based model, and a data access API is applied, here presented as a query language that resembles SQL while being geared towards traversal and manipulations. It is however to be understood that the access control framework created is independent of the data representation and the API framework used, and, thus, the framework works also with other forms of data representations and APIs than mentioned herein as well.

Access control is a key feature of the data store. The biggest motivation for users to host data in a data store is privacy. A data owner wants to control in a flexible way who has access to which part of the data and in which context. Furthermore, the data owner may also want to control what happens to the data after it has been shared with a third party. Such controls could be done in a manual fashion, such that every time some application requests access to certain data, the data owner is asked for confirmation. However, this is very cumbersome. An automated solution is therefore desirable, which generates access control decisions on behalf of the data owner. It should also support context information, such as e.g. location and/or time when making access control decisions.

Such an automated process could be enabled by the use of dynamically defined privacy policies, from hereinafter referred to as policies, which are evaluated in its present context at the time when data access is requested. A data owner who possesses multiple data stores, each being used for holding different domains of data, normally prefers to manage privacy policies at a single point of administration, as well as having access control decisions made there.

What is described herein is therefore a solution which aims to achieve at least the following objectives: (1) Dynamicity: any time a data owner reconfigures policies, they should take effect right away; (2) Granularity: a data owner should be able to protect data at varying levels of granularity, or in other words, to zoom in to the very low level and protect a very specific piece of data, i.e. a single data item, and should also be able to zoom out to a very high level and protect large classes of data, comprising a plurality of data items (3) Context-Awareness: access control decisions should be made, having the possibility of taking into account the present context (e.g. the data to be considered, the data owner, and/or the data requester); (4) Ease of Administration: a data owner should not have difficulties in understanding and managing privacy. The objects mentioned above should be achieved independently of access language and data storage used.

An access control architecture is suggested that offers data owners a central place to dynamically create and manage policies, as well as to support access control decisions based on the present context. In addition, mechanisms are introduced which enable protection of data at varying levels of granularity. This capability, referred to above as zooming, could also be said to mimic a “slider” for personal data protection, where data owners are able to tune the protection as needed, along a spectrum from all data units of a specific class or classes to each piece of smallest data units and everything in-between.

With the lack of fine granularity and dynamicity, existing policy based solutions, such as the ones mentioned above, do not deal with the protection of a particular small piece of data, which may have been dynamically deposited into a data store. The present document therefore also refers to a security and privacy framework for a data store architecture, thereby enabling data owners to have dynamic context-aware control of access to their data at varied granularities.

This document address the problem of achieving variable grained protection of data in a secure data store, herein provided as a data store, which protection may range from fine-grained to coarse-grained protection. The protection could vary from being coarse-grained at the level of any of data categories, such as e.g. tables or types, to being as fine-grained as at the level of the smallest identified data unit, such as e.g. a row, a node, or an edge, or be somewhere in between, e.g. at a sub-category or type level.

A hierarchical policy-based access control model is suggested which is applicable on requests on data that is accessible through a query interface in a data store. A data owner can define policies at a higher level, e.g. for classes defined in a class hierarchy that dictates the schema in which data is represented (for example, an ontology), where each class comprise a plurality of data items. Policies can also be defined at a lower level, such as e.g. policies applicable for particular data units. It is also possible to combine policies so that some aggregate data is specified with a policy using the class hierarchy while some smallest data units out of such an aggregation are covered by individual policies. The latter combined case may e.g. be exemplified by having a first policy defined for a group of objects, here denoted as “Music” objects, while having at the same time another, second policy defined for a specific data unit, e.g. the song “dream” being one of the “Music” objects. In this case only the second policy applies for the “song” data unit, while the remaining data units of the “Music” objects, i.e. of the class “Music” apply the first policy.

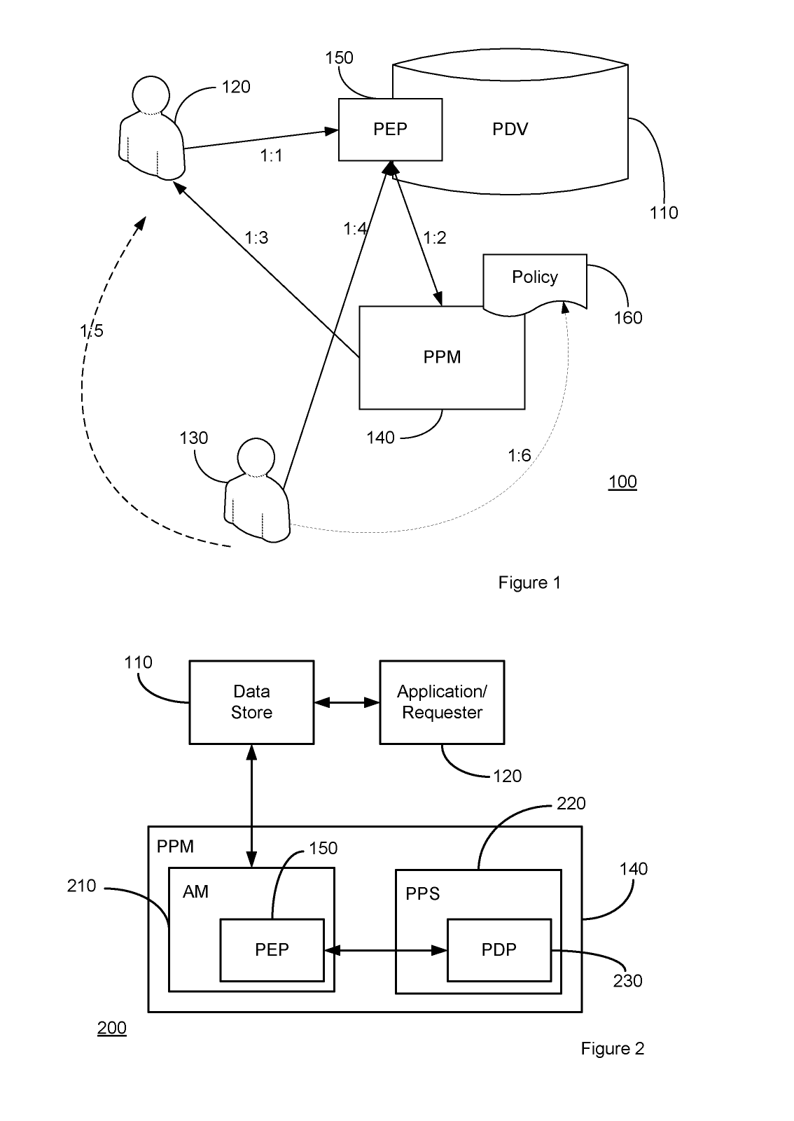

An overall security and privacy framework model for system 100, comprising a data store, here referred to as a Personal Data Vault (PDV) 110, such as the one mentioned above, is shown in FIG. 1.

As indicated in the figure a requester 120, which may be any of a service, an application or a software agent representing an individual user, may, as indicated with step 1:1, request to access data in the PDV of an owner 130, which may also be referred to as the PDV owner, which is the one responsible for determining how, and under what conditions, the requester 120 is to have access to the owners data in the PDV 110. A Personal Privacy Manager (PPM), 140 protects the access to the data of the PDV, by utilizing a policy enforcement point (PEP) 150, as indicated with step 1:2, where access decisions are made according to a policy 160, as defined by the owner 130, to be enforced at the PDV 110 when a request is evaluated, resulting in that the requester 120 is either authorized to access requested data or denied the same, as indicated with step 1:3. Such a policy may be expressed in PrimeLife Privacy Language (PPL), which is based on the eXtended Access Control markup Language (XACML), but other languages may be applied instead, such as e.g the Platform for Privacy Preferences Project (P3P), or the Obligation Specification Language (OSL). The policy 160 is stating which requesters are permitted to have access to what resources in what contexts. In the present context a resource could e.g. be a column family or an identifiable small data unit, where the ontology class resource is representing a high level protection while the small data unit represents a low level protection. It is to be understood that although the figure comprises only one PDV, a plurality of PDVs may alternatively be connected to the PPM. By managing the PEP 150, as indicated with step 1:4, the owner 130 delegates, as identified with step 1:5, to the system 100 to determine accept or deny access to data content requested by the requestor 120, according to the policies 160 applicable for the respective data. Here it is the PEP 150 that enforces deny or accept. Here it is the PEP 150 that enforces deny or accept. The owner 130 is also allowed to dynamically amend policies 160, as indicated with step 1:6.

The PPM can, in addition to data provided from the requester, take also additional context information, such as e.g. location and/or time, into account for its decision making. It can also support the input of a trust framework that gives recommendations about the trustworthiness of a service, like for example Web of Trust (WOT), http://www.mywot.com/, accessed in January, 2013.

An architecture 200 for providing the objectives mentioned above, focusing on the PPM 140 and the data store or PDV 110, is illustrated in FIG. 2, where a requester 120, here represented by an application, wanting to access data from the data store can access the PPM 140 via the data store 110.

As a pre-requisite any requester initially has to be authorized and localize a relevant PPM and register at the PPM to be able to request resources via an API, which may be referred to as a protection API part (not shown) which is accessible via the data store, while access to already registered resources can be requested via another API, which may be referred to as an authorization API (not shown). However, other APIs may be applied to enable communication between one or more data stores and the PPM. Resources can be registered dynamically at a data store or memory (not shown) of an Authorization Manager (AM) 210 when a policy for the respective resource is created.

After an approved registration the requester 120 may provide a request, which may be referred to as a data request or query to the data store 110 which redirects such a request to a PEP 150, which is here residing in the AM 210. Alternatively the PEP 150 can form part of a Privacy Policy Server (PPS) 220. A PPS 220, which alternatively may be referred to as a policy decision engine, comprises a Policy Decision Point (PDP) 230, which have access to policies previously defined by the owner which are stored in a data store or memory (not shown) of the PPS 220 or accessible to the PPS 220. The PEP 150 forwards the request to the PDP which evaluates the request against the policies, and makes a decision, which may also be referred to as an access control decision, Depending on the outcome of the evaluation, i.e. how well the request match a policy applicable for the requester 120, the PDP 230 may respond by approving or denying access to one or more resources. More specifically, the PDP 230 may respond with “Permit”, in case, after certain policies have been used for evaluating a request, the request has been explicitly permitted, “Deny”, in case policies have been used for evaluation of a request and the request has been explicitly denied, or “Indeterminate” or “NotApplicable”, in case no relevant policy has been found. Also in the latter two cases the request is denied. In the decision process the PDP 230 might consider also one or more attributes, defining e.g. the location of a user and/or some trust value of a service.

If allowed, the requester 120 will receive a token, typically referred to as a Request Permission Token (RPT) comprising applicable rights permissions, and thus, such a token can be used by the requester 120 to access resource/s from the data store 110, while in case of a denied request, the token will not comprise the required rights permissions. In the latter case, the requester 120 will not be able to access, but may try to update the token in order to get permitted access. Once in possession of a RPT the requester can send the RPT to the data store 110 which once again contacts the PEP 150 to determine which access the requester should be entitled to. Once the PEP 150 and PDP 230 have interacted based on the RPT, and possibly any additional attribute/s applicable for the requester 120, the data store 110 receives the result and filters out the resources which the requester 120 should have access to and the result is provided from the data store 110 to the requester 120, which can now access the respective resources. Although not explicitly shown if FIG. 2, PPS 220 also comprise editing functionality, allowing a user to edit policies stored therein or add new policies. Further details on the procedures mentioned above will be described in further detail below with reference to FIGS. 6-11c.

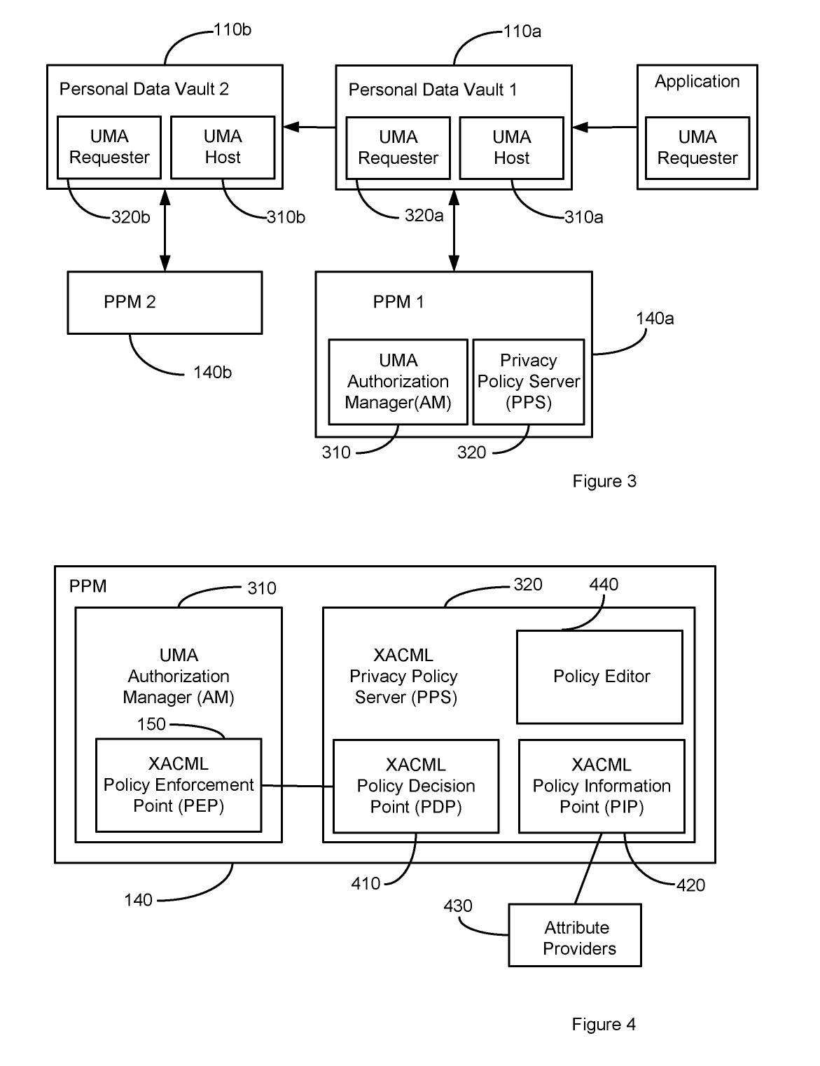

FIGS. 3-5 illustrate in further detail an example of the architecture described in FIG. 1 above, when based on the User Managed Access (UMA) model as defined in http://kantarainitiative.org/confluence/download/attachments/37751312/UMA_IEEE_PosterV08.pdf, combined with a PPS powered by the PrimeLife Privacy Language (PPL), which is based on XACML (eXtensible Access Control Markup Language), as described in S. Trabelsi, G. Neven, and S. Ragett, “Report on Design and Implementation,” PrimeLife Project, Tech. Rep. D5.3.4, May 2011. UMA is a web-based access management protocol, enabling web users to coordinate protection and sharing of web resources. The architecture of FIG. 3 comprises a UMA Authorization Manager (UMA AM), where the PEP resides, and a PPS, where policies are stored, access requests are evaluated and access control decisions are made in response to the access requests. In the present example the UMA AM has thus been enriched to become a PEP in the XACML architecture. In this UMA related example we again refer to a data store, which here is denoted personal data vault.

As indicated in FIG. 3, each of the PDVs 110a, 110b contains a respective UMA host part 310a, 310b that either lets data requests through or blocks them depending on the right permissions expressed in an access control decision, provided from the PEP to the requester. In the present embodiment the access control decision, is provided in the form of a token, here referred to as a UMA token, or an RPT.

Additionally, each PDV 110a, 110b may also, as indicated in FIG. 3, contain a respective UMA Requester 320a, 320b component, thereby allowing a PDV 110a to request data from other PDVs 110b in a distributed query.

The UMA model also includes scopes for data access which are mapped to actions in the PPL semantic. Currently “read” and “write” are supported as possible actions. In a “read” action it is assumed that data is shared, while a “write” action also includes deletion of data units.

The individual components in the UMA architecture will be described in further detail below.

A. Personal Privacy Manager

The PPM as shown in detail in FIG. 4 contains a UMA AM 310 and also a Personal Policy Server (PPS) 320. One or more PDVs, each of which is operable as a data host, hosting resources that need to be protected according to policies, are registered at a data store or memory (not shown) of the AM 310 of the PPM 140. The UMA AM 310 is connected to a PEP 150, here provided as an XACML PEP, which is shown here as forming part of the UMA AM 310, but which could alternatively be arranged outside the UMA AM 310, instead forming part of the PPS 320.

1) UMA Authorization Manager

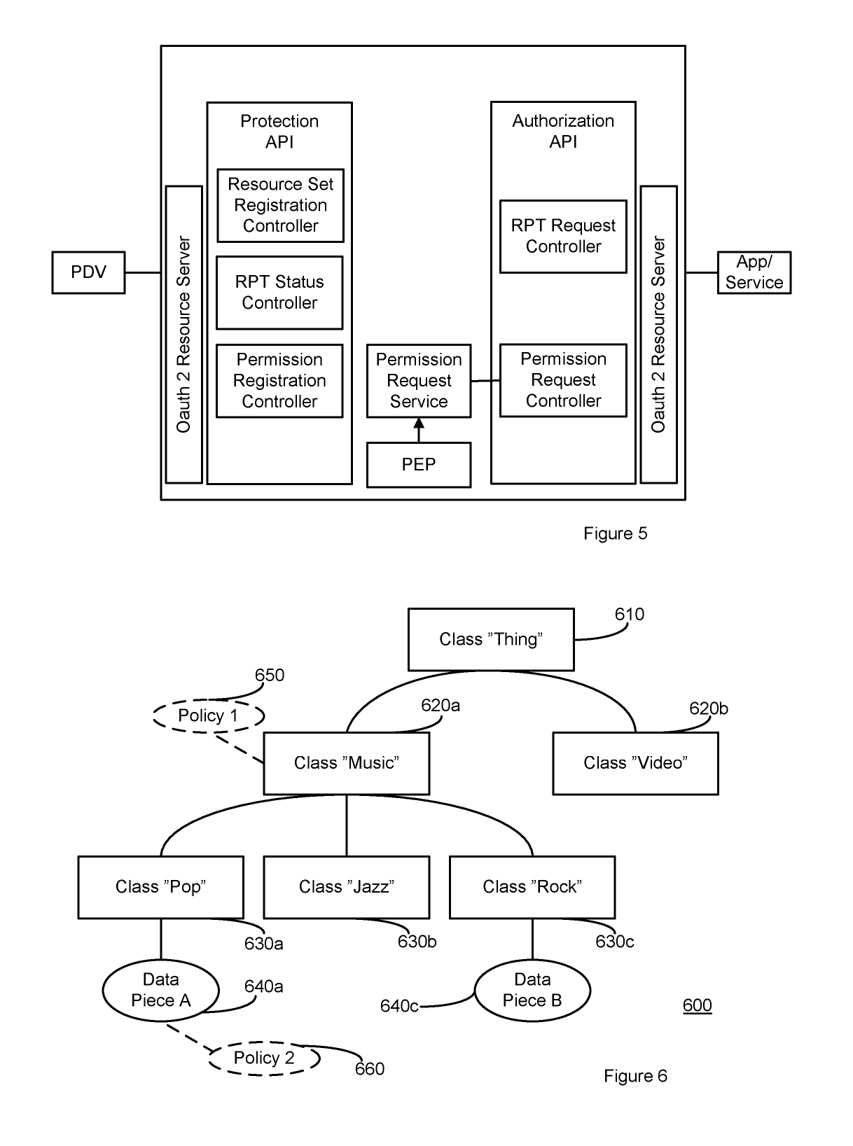

The UMA Authorization Manager (AM) 310 as shown in further detail in FIG. 5 is based on the specification T. Hardjono, User-Managed Access (UMA) Core Protocol, draft-hardjono-oauth-umacore-04, Internet Draft, Mar. 29, 2012 with some minor modifications in order to be able to apply also an XACML policy architecture as mentioned above. The UMA AM provides a Permission Request Service which is connected to the PEP and which allows an RPT to be given to the requester (if the PEP receives a “Permit” access control decision from the PPS) and the permissions of the RPT to be updated or not.

The UMA AM also comprises a protection API part, which is accessible by the one or more PDVs connected to the PPM, and which is used for registering of resources of one or more PDVs at the PPM, while an authorization API is used to control access to registered resources when requested by a requester. Resources can be registered dynamically with the UMA AM when a policy for the respective resource is created.

An RPT can contain permissions or be without permissions to access the requested resource. In the latter case the RPT is considered as an empty RPT. In the authorization API, a RPT Request Controller is configured to hand out an RPT if allowed and the Permission Request Controller is configured to hand out an updated RPT with the necessary permissions in case of an update procedure, as will be explained in further detail later in this document.

Additionally the requester registers itself at the AM in order to be able to receive RPTs. At the Permission Registration Controller the PDV indicates to the AM which permissions are needed for a specific access.

The RPT status controller interacts with the one or more PDV connected to the PPM to inform what permissions are associated with particular RPTs provided to a requester and then presented to a respective PDV by a requester.

2) Privacy Policy Server

The Privacy Policy Server (PPS) 320 shown above in FIG. 4 also follows the XACML policy architecture, as laid out in E. Rissanen, “eXtensible Access Control Markup Language (XACML) Version 3.0,” August 2010, and comprise, in addition to a policy enforcement point (PEP) 150, here residing in the UMA AM 310, a policy decision point (PDP) 410, and a policy information point (PIP) 420. In this architecture the actual decision on access requests are made based on a policy. The PDP 410 receives an authorization request from the PEP 150 and answers, either with “Permit”, “Deny”, “Indeterminate” or “NotApplicable”. In the decision process the PDP 410 might need one or more attributes, the location of a user and/or some trust value of a service. These attributes are provided by the PIP 420. The PIP 420 itself provides an interface for one or more attribute providers 430, so that several attribute providers can be connected to the PIP 420 also at a later point of time. Additionally, the PPS 320 provides means for a owner to edit, i.e. add, amend or delete the policies. This could be a graphical policy editor 440, as indicated in FIG. 4, or a text editor which allows a user to edit the privacy policy.

As already mentioned, an aim with the architectures described above is to enable a policy-based protection of data at varied levels, which means that a data owner is able to “zoom in” to a very low level and protect a resource defined by a particular small piece of data, and on the other hand to “zoom out” to a very high level and protect a resource defined by a large class of data.

The data stored in a PDV is structured. Such structures can always be viewed as a hierarchy, regardless of the persistence technology used. In one case, the hierarchy can be arranged as a table-column element hierarchy, while in another case, if the schema of data is governed by an ontology, the hierarchy may be arranged as classes and subclasses defined in the ontology. In such a hierarchical policy structure, a policy at a lower level of the hierarchy covers a smaller amount of data but is of finer granularity. When certain data is being requested, the policy hierarchy is searched in order to find the most fine-grained policy that pertains to the data concerned. The data request will be evaluated against the relevant privacy policy for making an access control decision. Further details on how such a search can be executed will be described later in this document.

FIG. 6 is illustrating an example of a hierarchy policy structure where we assume that resources, comprising one or more data items, or data pieces, which are arranged in different classes in a data store is represented following a simple ontology. The class hierarchy of the ontology is a tree 600, rooted at a higher class 610 denoted “Thing”. Below “Thing”, there are two subclasses 620a, 620b, denoted “Music” and “Video”, respectively. Subclass “Music” 620a is further categorized into the three subclasses 630a, 630b, 630c, denoted “Pop”, “Jazz” and “Rock”, respectively. Now assume that there are two pieces of data—Data Piece A 640a, belonging to the “Pop” class 630a, and Data Piece B 640c, being of the “Rock” class 630c. Also assume that two policies have been defined, Policy 1 650 for the “Music” class 620b and Policy 2 660 for Data Piece A 640a. If there is a request for Data Piece A 640a, Policy 2 660 will apply and override Policy 1 650, as Policy 2 660 is more specific for Data Piece A 640a. In contrast, if the data request is for Data Piece B 640c, Policy 1 650 will apply, as this data piece does not have a policy defined for it, and thus, the first policy defined for a higher class is policy 1 650, which is therefore the most specific policy for Data Piece B 640c.

This model gives data owners a “slider” to tune the granularity of data protection as they need. In one extreme case, a less privacy-concerned data owner defines one single policy covering all data in a data vault. In the other extreme case, a highly conservative data owner has a policy for each individual piece of data in a data vault. In a typical scenario most data owners would fall somewhere in between, having policies for large classes of data, as well as defining some exceptions for particular data pieces.

In the UMA example mentioned above, PPL is suitable due to its extension of the XACML privacy features and XACML itself, being an industry standard for which implementations are available. PPL allows expressing access and usage control policies. Thus, it allows the data store/PDV owner to specify how data from the data store should be treated by the receiving entity. In addition to generating a new policy this can be achieved also through extending an existing XACML privacy profile with more obligations.

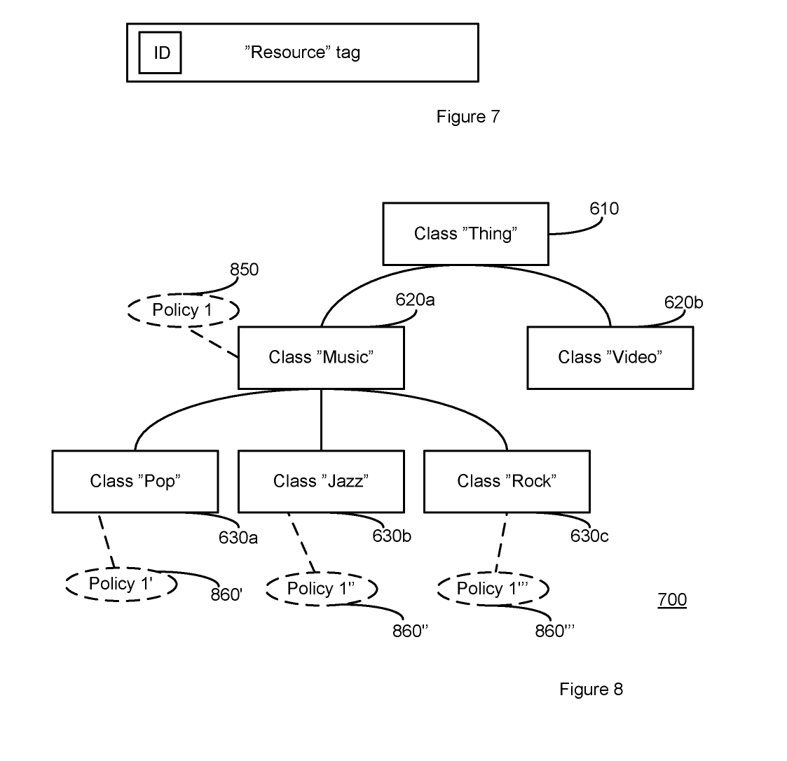

In the described context policy management has to do with mapping policies to the data or resources they protect, maintaining policies in a hierarchical structure, and handling operations like search, creation, update and deletion of policies. To address the mapping between policies and data, a tag, here referred to as a resource tag of the “Target” section of PPL is used. A policy, in its PPL representation, describes the resource(s) it protects using the Resource tag. In the case of a policy that pertains to a class of data, a unique name or identity (ID) of a respective class is placed inside the Resource tag. In case of a fine-grained policy defined for a particular data unit, the unique ID or name of the data unit is instead placed in the Resource tag, as indicated in FIG. 7. With regards to maintaining the policy hierarchy and handling operations, a few approaches are possible. Each of them comes with its pros and cons in terms of simplicity, storage efficiency and search efficiency. The selection of which approach to go after in implementations is a balance of tradeoffs.

An example of a policy for a resource referred to as “Music” is illustrated below:

```
<Policy PolicyId=“Music” RuleCombiningAlgId=“urn:oasis:names:tc:xacml:1.0:rule-
combining-algorithm:deny-overrides”>
  <Description>Permit LeStress' read access to class “Music”</Description>
    <Target>
    <Subjects>
      <Subject>
      <SubjectMatch MatchId=“urn:oasis:names:tc:xacml:1.0:function:string-
      equal”>
      <AttributeValue
DataType=http://www.w3.org/2001/XMLSchema#string>LeStress
      </AttributeValue>
      <SubjectAttributeDesignator AttributeId=“urn:oasis:names:tc:xacml:2.0:example:
      attribute:OriginalRequester”
DataType=“http://www.w3.org/2001/XMLSchema#string” />
      </SubjectMatch>
      </Subject>
    </Subjects>
    <Resources>
    <Resource>
    <ResourceMatch MatchId=“urn:oasis:names:tc:xacml:1.0:function:string-equal”>
      <AttributeValue DataType=“http://www.w3.org/2001/XMLSchema#string”>Music
      </AttributeValue>
      <ResourceAttributeDesignator AttributeId=“urn:oasis:names:tc:xacml:
    1.0:resource:resource-id” DataType=“http://www.w3.org/2001/XMLSchema#string”
/>
    </ResourceMatch>
    </Resource>
    </Resources>
    </Target>
    <Rule RuleId=“AllowMusicReading” Effect=“Permit”>
    <Condition FunctionId=“urn:oasis:names:tc:xacml:1.0:function:and”>
      <Apply FunctionId=“urn:oasis:names:tc:xacml:1.0:function:string-equal”>
      <Apply FunctionId=“urn:oasis:names:tc:xacml:1.0:function:string-one-and-
      only”>
        <ActionAttributeDesignator DataType=“http://www.w3.org/2001/
        XMLSchema#string” AttributeId=“urn:oasis:names:tc:xacml:1.0:action:action-
        id” />
        </Apply>
      <AttributeValue DataType=“http://www.w3.org/2001/XMLSchema#string”>read
      </AttributeValue>
      </Apply>
      </Condition>
    </Rule>
    </Policy>
```

Three different approaches for how to store policies will now be described below, where different resources are referred to as, or belong to, a class or a subclass. A sub class is however not exclusive. More specifically, a single data item belong not only to a respective sub class, but also to the class to which the sub class belongs.

The way a policy hierarchy is actually persisted fully determines the storage efficiency and search efficiency of a policy management model. It also partly determines the efficiency of operations, like update and deletion. The following three approaches vary in how they maintain the linkage between relevant policies.

Policy Replication: In a first approach, which is illustrated in FIG. 8, a policy, policy 1 850 is created for a class or resource “Music” 620a in a data hierarchy 700, wherein additional policies, e.g. policy 1′ 860′, policy 1″ 860″ and policy 1′″ 860′″, respectively are also, at the same time, created for all its subclasses that do not already have any existing policy, in the present example this implies all three subclasses of class “Music” 620a. The latter policies replicate the content of the former, except the resources they protect. Looking at the previous example, illustrated above with reference to FIG. 6, FIG. 8 illustrates what happens when a policy is created for class “Music” 620a by replication and none of its subclasses have any existing policy. A search of such a policy is executed in just one step, by matching the resource ID or name of each respective resource to stored policies and by applying the relevant policies. If, during such a search, there is no match, this means that no policy exists for this resource, and since no policy exist, all such requests should be denied by default. This approach is the simplest and most search efficient of the ones suggested herein. Obviously, the cost that comes with the simplicity of this approach and search efficiency is its low storage efficiency. Therefore this approach is more suitable for less complicated data hierarchies.

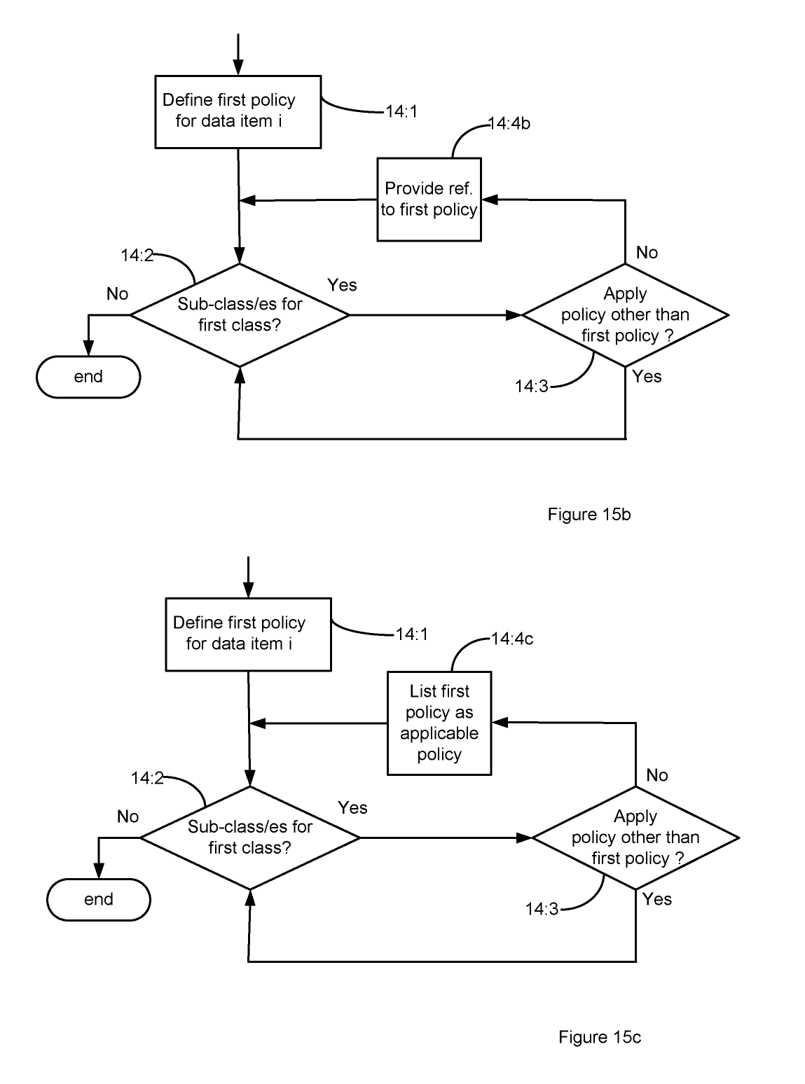

A policy replication method, such as the one described above, is also illustrated with reference to FIG. 15a, where in a first step 14:1 a policy, here referred to as a first policy, is defined for a certain class. If there is one or more sub-classes for the respective class, for which no policy has previously been defined, the first policy will be defined also for these sub-classes, as indicated with steps 14:3 and 14:4a. In the present case the content of the first policy is replicated to each policy applicable for a relevant sub-class of the class mentioned above, as indicated in step 14:4a. In step 14:2 and following steps 14:3 and 14:4a, the same considerations are repeated sub-classes of a class. In case a policy other than the first policy is defined for one of the sub-classes mentioned above, no duplication of the first policy is executed for that sub-class.

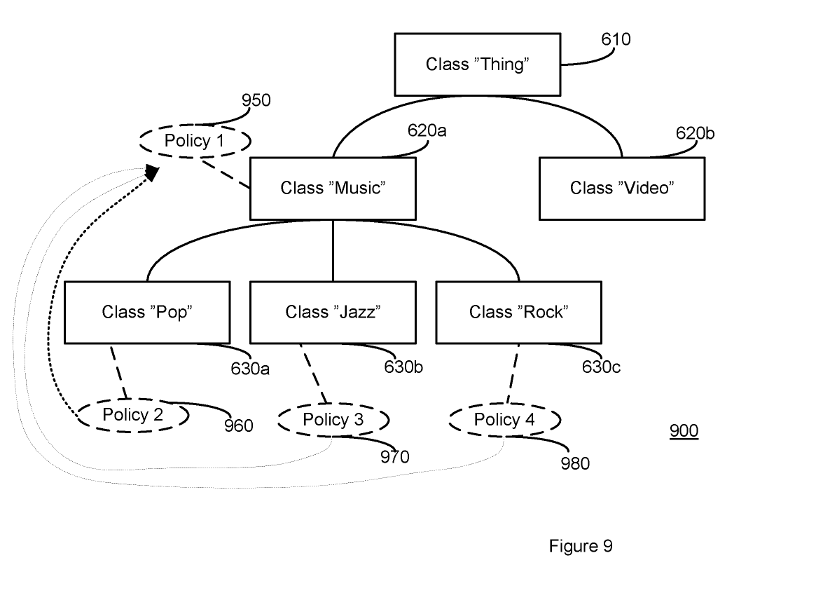

Policy Chaining: In a second approach, which is illustrated in FIG. 9, a policy, policy 1 950 is created for a certain class, “Music” 620a in a data hierarchy 900, while additional, respective policies 960,970,980 are also, at the same time, created for its subclasses “Pop” 630a, “Jazz” 630b, and “Rock” 630c, respectively, that do not have any existing policy. As the latter policies all contain the same content as the former, except the resources they protect, each of these policies will keep a respective reference to the former policy instead of replicating the content of the policy as was done in the former approach. This may be done by using a parameter, here referred to as “PolicyldReference tag”. The use of such a reference saves space and thus is fairly storage efficient. In addition it is also fairly search-efficient. When a search is performed for the most specific policy protecting a resource, the policy could be quickly located by matching the resource ID or name with the privacy policies, and in some successful cases the actual content can be retrieved either directly of by following the respective reference.

A policy chaining method, such as the one described above, is also illustrated with reference to FIG. 15b, where in a first step 14:1 a policy, referred to as a first policy, is defined for a certain class. If there is one or more sub-classes for the respective class, for which no policy has previously been defined, the first policy will be defined also for these sub-classes, as indicated with steps 14:3 and 14:4b. In the present case, however, this is executed by providing a reference to the first policy for a relevant sub-class of the class mentioned above, as indicated in step 14:4b. In step 14:2 and following steps 14:3 and 14:4b, the same considerations are then repeated for each sub-class of the mentioned class. In case a policy other than the first policy is defined for one of the sub-classes, the described policy chaining is not executed for that sub-class.

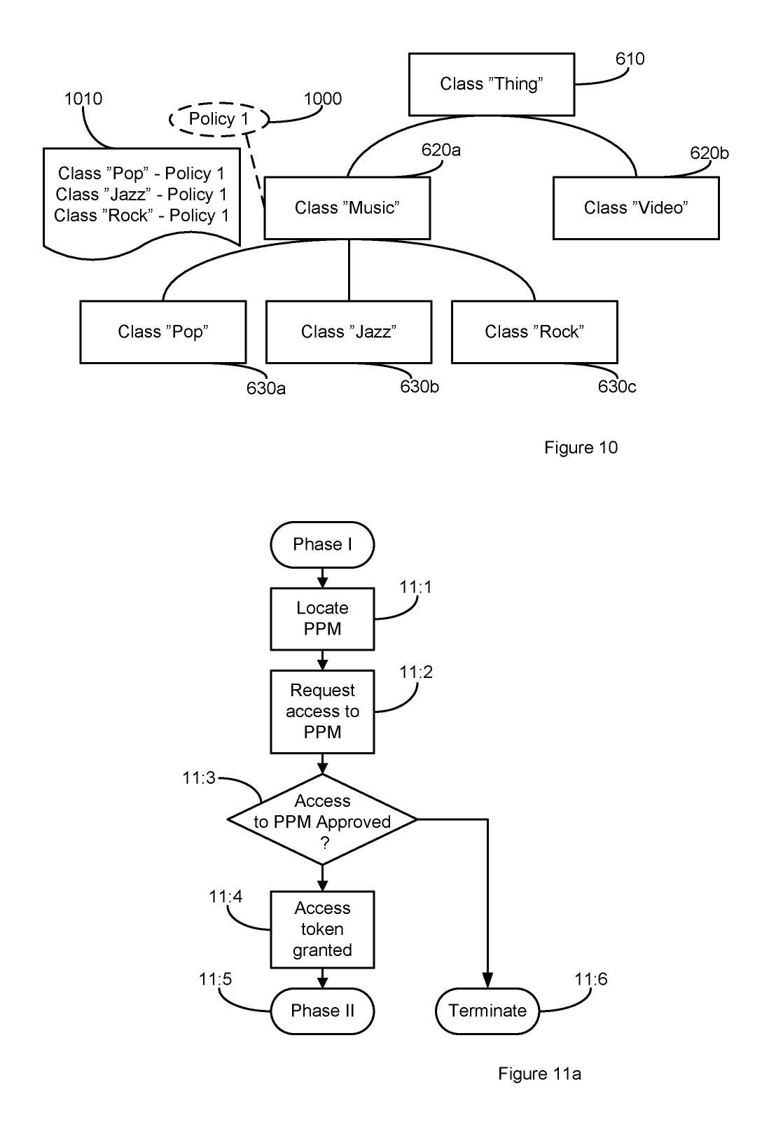

Policy Aggregation: In a third approach, which is illustrated in FIG. 10, a policy 1000 is created for a class in the data hierarchy, here the class “Music” 920 a, while no additional privacy policies are created for any of its subclasses “Pop” 630a, “Jazz” 630b, and “Rock” 630c. Instead, all subclasses of class “Music” which do not already have an existing policy defined for it will be listed as resources in the policy created for class “Music”. This is the most storage efficient approach of the suggested ones. In addition, search is also made more efficient than the chaining approach, requiring just one step—maximum only one reference has to be resolved for finding the appropriate privacy policy. Nevertheless the suggested process may make updates and deletions either simple or more complex, depending on the policy operation handling approach employed.

A policy aggregation method, such as the one described above, is also illustrated with reference to FIG. 15c, where in a first step 14:1 a policy, referred to as a first policy, is defined for a certain class. If there is one or more sub-classes for the respective class, for which no policy has previously been defined, the first policy will be defined also for these data items, as indicated with steps 14:3 and 14:4c. In the present case, however, this is executed by listing the respective sub-class as a sub-class for which the first policy is to be the applicable policy, as indicated in step 14:4c. In step 14:2 and following steps 14:3 and 14:4c, the same considerations are repeated for each sub-classes of the mentioned class. In case a policy other than the first policy is defined for one of the sub-classes mentioned above, the described policy aggregation method is not executed for that sub-class.

Policy operation handling concerns what happens to relevant policy when it is created, updated or deleted—whether the respective operation should be cascaded to subclasses having policies with the same content. As already mentioned, creation is always a cascading operation. That is, when a policy is created for a class, policies are also created for its subclasses that do not have any existing policy. This makes sense for creation operations due to the nature of the hierarchical policy structure. For updating and deletion operations, there are the options of cascading and non-cascading. The selection of which option to choose is not only a technical matter, but also a user experience design consideration, which is more intuitive and understandable to end users.

With cascading operations, when a policy for a certain class is up“Pop” 630a, “Jazz” 630b, and “Rock” 630c dated, the policies defined for its subclasses, having the same content, are updated accordingly. When a policy for a class is deleted, policies defined for subclasses having the same content are deleted as well. This model works particularly well together with the policy aggregation persistence approach, since in such a situation only one physical policy needs to be altered or removed.

With non-cascading operations, when a policy for a class is updated or deleted, no other policies are affected. This model works particularly well together with the policy replication persistence approach, since in such a situation only one physical policy needs to be altered or removed.

Below it will be described in further detail how a data request can be handled in a layered manner in two different authorization flows. At the lower layer is a regular authorization flow, through which a data request for a particular resource can be handled. At the higher layer, where an actual request might be in the form of a query, from which what resource(s) are being requested cannot be told, the flow deals with the uncertainty and complexity of such a query.

Assuming that a resource being requested at a data store is specified in a request in the form of an identifiable data unit or a data class, the workflow of authorizing a requester to access the requested resource follows the UMA workflow as described above. UMA is based on OAuth 2.0 and extends it by specifying the communication between the authorization server, i.e. the AM, and the resource server, i.e. the data store used. At the time of writing, the UMA specification is being rewritten as a OAuth 2.0 profile.

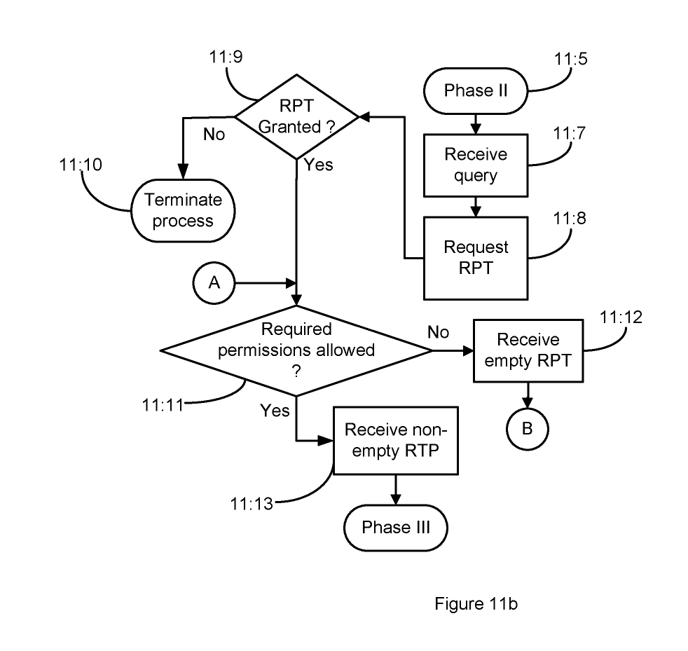

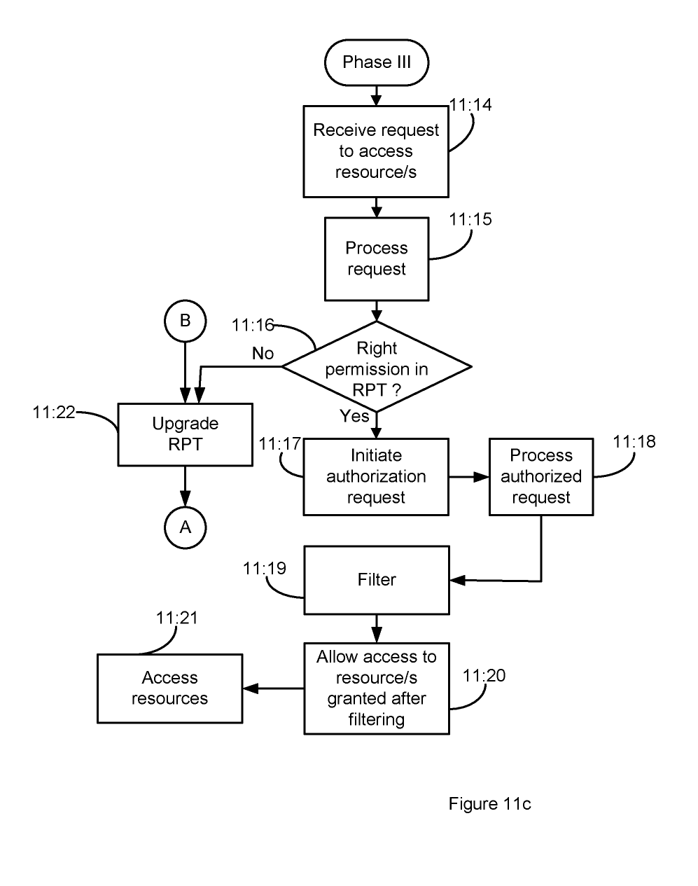

The workflow can be divided into three phases. The first phase, which is illustrated in FIG. 11a, is looked upon from a requesters point of view. As indicated in step 11:1, a requester locates, or identifies, the PPM that protects a certain data store. This is achieved by the data store redirecting the requester to the PPM, or by sending configuration information to the requester in which the location of the PPM is stated.

Once the relevant PPM has been identified, the requester attempts to access the PPM, as indicated in step 11:2 and 11:3. If access is approved, as indicated in step 11:4, an access token is granted to the requester and a second phase, phase II can commence, as indicated with step 11:5. If no access is approved, i.e. the requester does not have access to the relevant PPM, the process is terminated, as indicated in step 11:6.

Phase II is described with reference to FIG. 11b. The requester, now being entitled to access the PPM, starts by issuing and receiving a query, as indicated in step 11:7. Such a query could e.g. be expressed as: http://localhost:8080/pdv/query?q=SELECT title FROM Music. In a next step 11:8 the data store issues a request for an RPT to the PPM, which request may be expressed e.g. as: http://localhost:8080/ppm/requester/rpt.

At the PPM policies are considered, in order to determine if an RPT should be granted, as indicated in step 11:9, and if certain policies dictates so, no RPT will be granted and the process is terminated, as indicated with step 11:10. If instead an RPT is granted the RPT may be an “empty” RPT, i.e. an RPT which is not associated with any permissions. Such an empty RPT is received by the requester in step 11:11. If permissions are granted, in step 11:12 an RPT indicating such permissions will instead be issued by the PPM. Such an RPT is received by the requester in step 11:13. The RPT is provided from the PPM to the requester.

As indicated in initial step 11:14 of FIG. 11c, phase III, which is to a large extend illustrating the processes executed in the data store, is initiated by the data store receiving a request from the requester issuing the same query as earlier, i.e. in the present case “http://localhost:8080/pdv/query?q=SELECT title from Music” again to the data store. This time, however the RPT is inserted into the HTTP authorization header of the request. The data store processes the query, as indicated in step 11:15, which includes generating an unfiltered result, i.e. all resources identified from the request. For each resource in the unfiltered result it is checked at the data store if the right permissions are contained in the RPT, as indicated in step 11:16. If this is the case, the data store initiates an authorization request, as indicated in step 11:17, which is sent to the PPM and processed accordingly, as indicated in step 11:18, by checking the request against the policies. Even though this process is executed only once in the figure it is to be understood that typically the process described by steps 11:16-11:18 is repeated for each resource that is identified in step 11:16, i.e. each time right permissions are contained in the RPT for a resource it triggers a separate authorization request. The result from this process, i.e. the requests triggered in step 11:17 may either be sent to the PPM as separate authorization requests or as a combined request, still triggering separate checks with the policies at the PPM. The result of the process is provided from the PPM to the data store in one or more responses, which may also be referred to as, filter lists. In a next step 11:19 the data store filters out denied resources from unfiltered result, based on the filter list/s, and as a result, the data store assembles a response to the access request, allowing the access only to the resources granted after the filtering, as indicated in the final step 11:20, and provides that response to the requester, as indicated in step 11:21, who can now access allowed resources accordingly.

If it is determined by the data store that the requester does not come with the right permissions, the requester is redirected to the PPM again for an upgrade of the RPT with the required permissions. This is indicated with step 11:22, redirecting again to phase II, as indicated with “A” where the steps from 11:11 onwards are repeated. Also in case of an empty RPT, the upgrade process is initiated, as indicated with “B”. In case of an upgrade RPT process, the PPM then again locates the applicable policy, and if found, evaluates the request against it. As a result, an upgrade of the RPT is either granted or denied (if no applicable policy can be found, it is denied too). In the former case, the PPM updates in its record-keeper the association of the RPT with the added permissions. The requester then presents the upgraded RPT to the data store (which again checks with the PPM) and in return may get access to resources. The result of the upgrade may differ from the previous attempt e.g. due to the change of time since the earlier attempt.

The basic workflow alone does not work in cases where the resources to be accessed are unspecified in the request. For example, if the request is in the form of a SQL or SQL-like query, such as “SELECT title FROM Music”, the request explicitly specifies only one resource “Music”, but the result of the query might include other resources that are finer grained (e.g., a specific music title that comes with its own policy). Hence, a higher-layer workflow is introduced to deal with the complexity brought by queries, and in the meantime decouple the UMA logic from query processing. For understandability, we use the SQL syntax in describing the higher-layer workflow below. In the case of a SELECT query, a post-authorization flow is applied. This means that the query is processed first to get an unfiltered result, so that all the resources that are actually being requested are identified. With that, it is then determined which of those resources are accessible to the requester, through the lower-layer flow. The result of the query is then filtered to return only those entries that the requester is permitted to access. The exact steps of this process are as follows.

1) The data requester issues a SELECT query which is sent to the data store. By way of example such a query may be expressed as: SELECT title FROM Music
2) The data store modifies the SELECT query by adding three properties to SELECT, namely: id (the ID of each data unit), type (the most specific class of each data unit) and policy (a flag indicating whether each respective data unit comes with its own policy). In the present example the query may be expressed as: SELECT_id,_type._policy, title FROM Music.
3) The data store processes the received query, resulting in an unfiltered result which contains one or more data units. The present example results in: ((id1, ‘Music’, false, ‘Silent Night’), (id2, ‘Music’, true, ‘Amazing Graze’), (id3, ‘Music’, false, ‘Bad Romance’))
4) The processing continues by the data store identifying the resources that are being requested, i.e., the most specific class(es) of the data units and the data units that come with their own policies.
5) The data store formulates authorization requests in the form of (requesterID, resourceID, action) tuples and sends them to the PPM. The present example results in: (‘Requester’, ‘Music’, ‘Read’), (‘Requester’, id2, ‘Read’)
6) The PPM responds to each authorization request by processing the request by locating the policy that matches the respective (requesterID, resourceID, action) tuple, and evaluating the request based on the policy. The present example results in: “Permit” on (‘Requester’, ‘Music’, ‘Read’), “Deny” on (‘Requester’, id2, ‘Read’). This result is then provided to the data store in the form of a filter list.
7) Based on the result provided from the PPM the data store filters out the entries in the result that did not receive a “Permit” decision. The present example results in: ((id1, ‘Music’, false, ‘Silen night’), (id3, ‘Music’, false, ‘Bad Romance’))
8) The data store returns the result from the filtering to the requester, which now indicates the resources which the requester is allowed to access. The present example results in: ((‘Silent Night’), (‘Bad romance’))

In the case of an INSERT query, a particular data unit is specified and hence the resource to be inserted is identified. A preauthorization flow makes such a flow much simplified, and can be exemplified as follows:

1) A data requester issues an INSERT query which is sent to the data store. Example: INSERT INTO Music (title) VALUES (‘Day and Night’)
2) The data store formulates an authorization request in the form of a (requesterID, resourceID, action) tuple and sends it to the PPM (the resourceID is the type of the data unit to be inserted). The present example results in: (‘Requester’, ‘Music’, ‘Write’)
3) The PPM responds to the authorization request by locating the corresponding policy and evaluating the request against it, and makes an access decision. The present example results in: “Permit” on (‘Requester’, ‘Music’, ‘Write’), which is provided as a response to the data store.
4) If the decision is “Permit”, as in the present example, the data store processes the query, by inserting the resource in question according to the relevant policy.

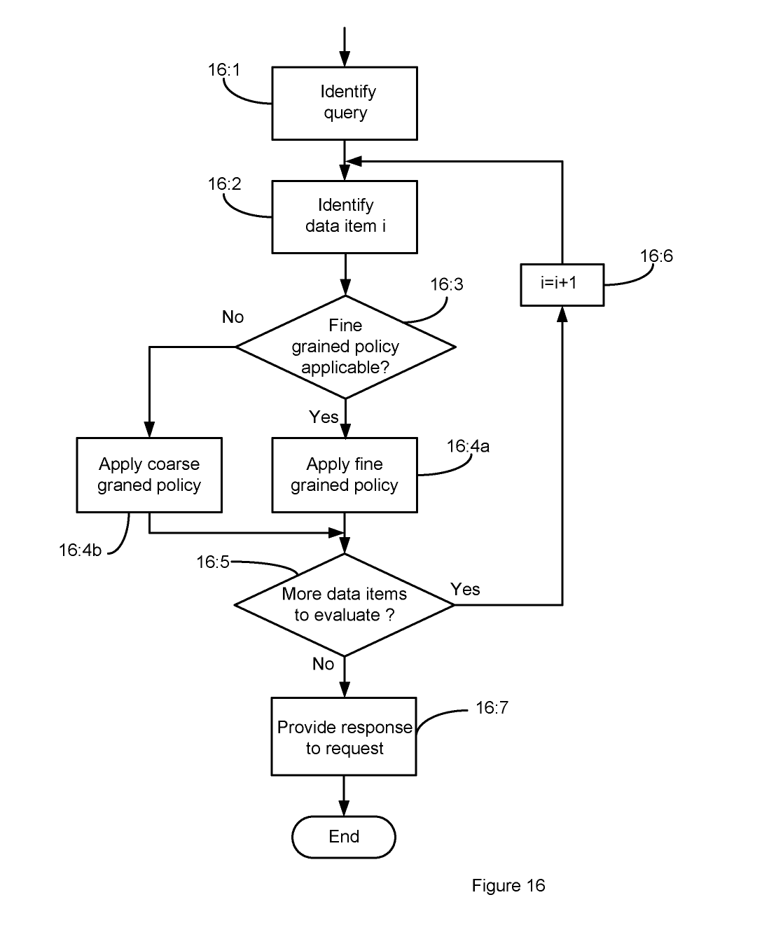

The process describe above can be described also with reference to FIG. 16, which is a simplified illustration of a method for searching for a specific query provided from a user, where in step 16:1, the query is first identified. In a next step 16:2, identification of relevant data items, i.e. the data items which correspond to the query and which are accessible to the user, is initiated. More specifically, policies, which can have been defined according to any of the different methods described previously in this document, are considered, as indicated in step 16:3. As already mentioned, any fine grained policy applicable for a data item of a class or sub-class will override an existing coarse grained policy, as indicated with alternative steps 16:4a and 15:4b. As indicated with step 16:5, the described process is repeated for all identified, relevant data items of a class and associated sub-classes. Once the respective policy has been applied at each level in the relevant hierarchy a response, comprising each of the data items, which according to the respective policy, are made accessible to the user in a response to the query, as indicated in step 16:7. UPDATE and DELETE queries follow similar patterns, as will be described below.

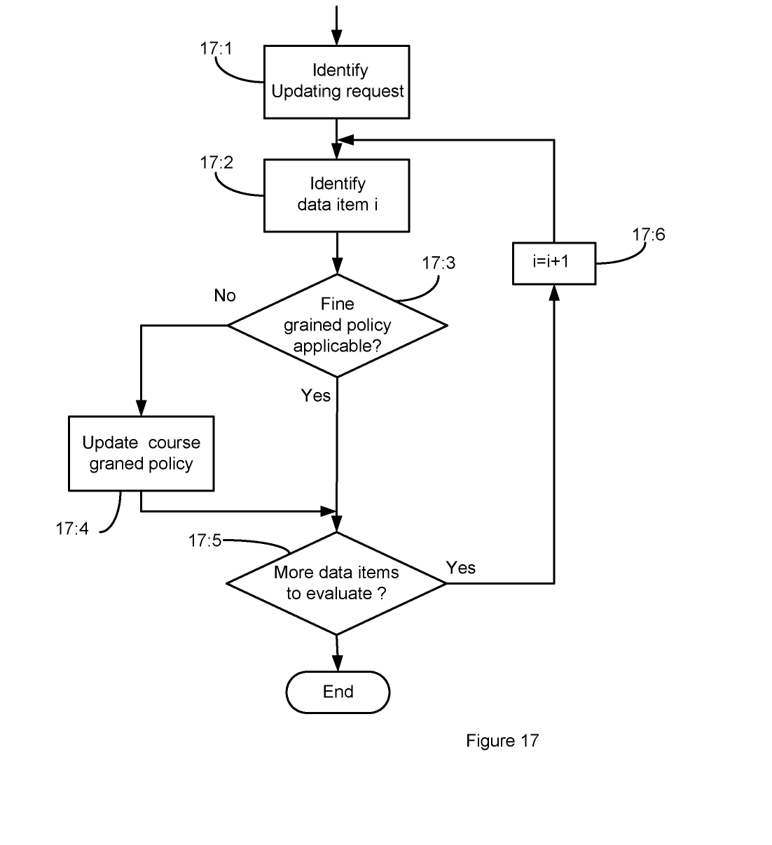

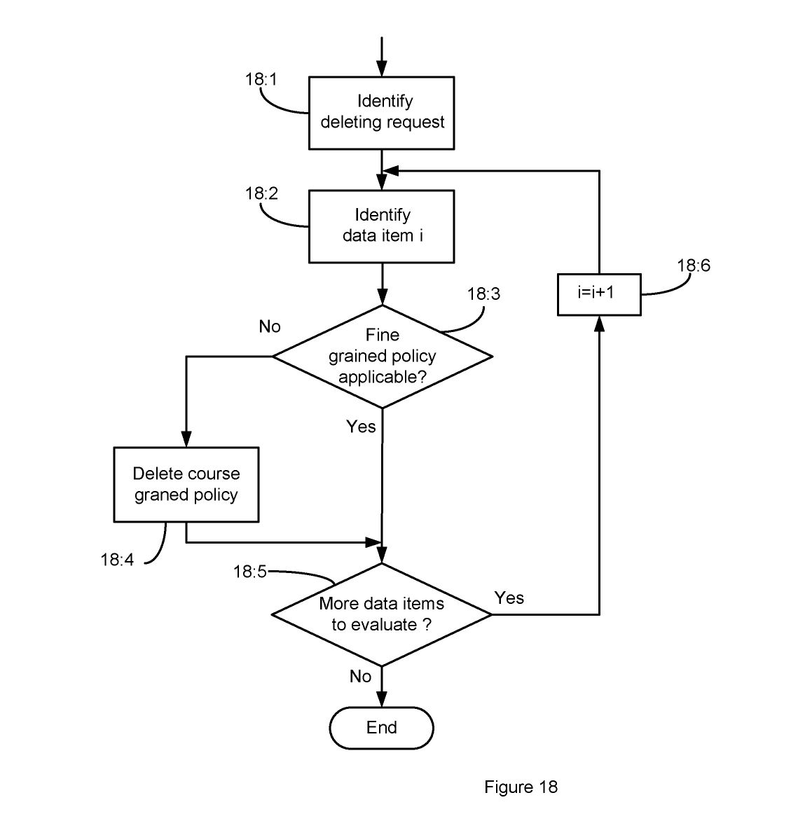

As can be seen in FIG. 17, steps 17:1-17:3 correspond to steps 16:1-16:3, while step 17:5 and 17:6 correspond to step 16:5 and 16:6, respectively. In case of determining a fine grained policy for a data item in step 17:3, no update of the policy applicable for that data item is executed. If, however, only a coarse grained policy has been defined for a respective data item, the coarse grained policy is updated also for that data item. In FIG. 18 a corresponding method for deleting a policy is illustrated, where steps 18:1-18:3 correspond to steps 16:1-16:3, while step 18:5 and 18:6 correspond to step 16:5 and 16:6, respectively. In case of determining a fine grained policy for a data item in step 18:3, no deletion of the policy applicable for that data item is executed. If, however, only a coarse grained policy has been defined for a respective data item, the coarse grained policy is updated also for that data item.

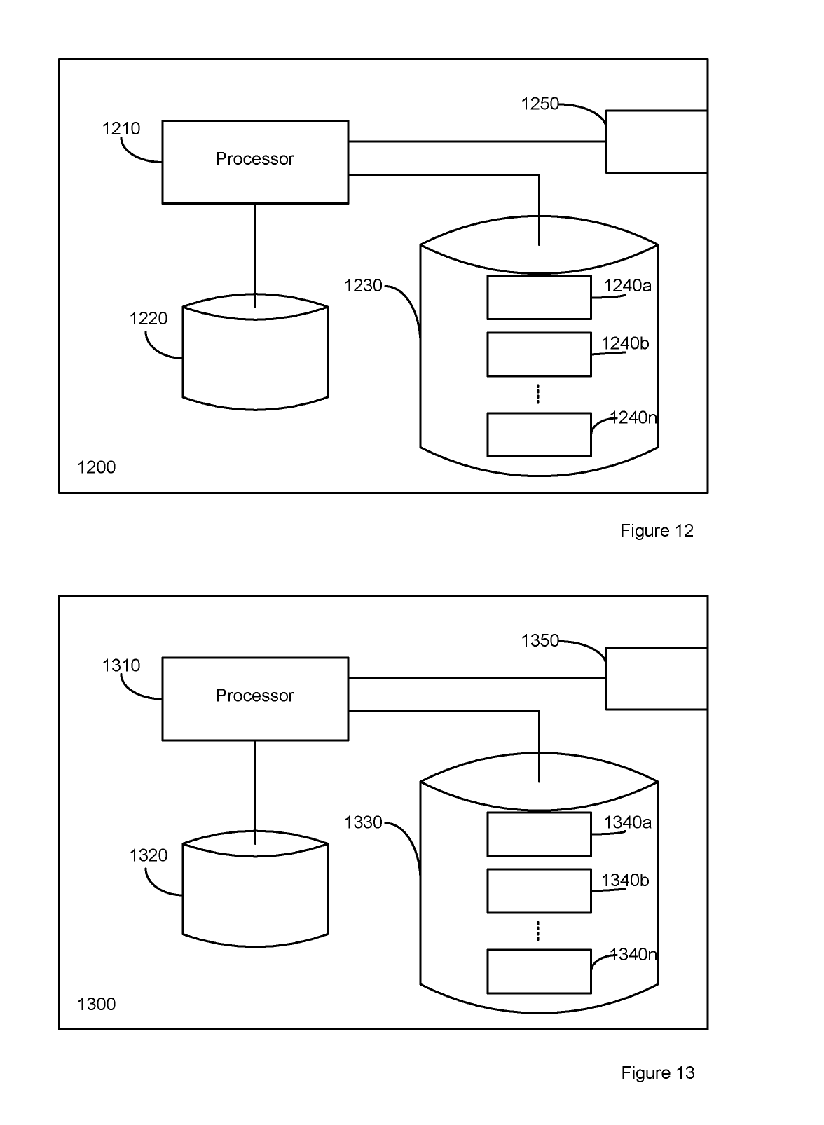

A data store is suggested which may be configured as illustrated in the simplified FIG. 12, where the data store 1200, which could alternatively be referred to as a PDV or data vault, comprises a processor 1210 and a first memory 1220 for storing resources, as described in this document and a communication interface 1250 for allowing communication with interacting entities, such as user devices managed by a requester and a PPM. The data store 1200 also comprises a second memory 1230 comprising instructions which when executed by the processor 1210 causes the processor 1210 to execute a method or process, such as any of the ones described above in this document, such as adding accessible data, herein referred to as resources to the first data store 1220; to edit already stored data, or to process an access request, or query, or a registration request as described herein. Such instructions may be arranged in one or more interacting modules 1240a-1240n, which provide functionality allowing the data storage to act as a host towards a requester. More specifically such modules may comprise at least a GUI for allowing an owner to view and interact with data and ontologies. By clicking to a specific piece of data or particular class in an ontology the data owner will be redirected to the PPM and will thus be able to add and edit policies stored in a PPM. APIs required for allowing the data store 1200 to communicate with a PPM is typically also included. The GUI and APIs may be selected from any known suitable alternative, and the functionality of these are therefore out of the scope of this document. In addition, the second memory 1230 may comprise modules, such as e.g. a redirecting module for redirecting a requester to a PPM, a processing module for processing access requests received from a requester, and filtering module for filtering responses to authorization requests received from the PPM. However, other combinations of functional modules may be applied instead as long as the functionality as described in this document can be executed.

A PPM is also suggested which may be configured as suggested in FIG. 13, where the PPM 1300, comprises a processor 1310, a first memory 1320 for storing policies organized as described in this document and a communication interface 1350 for allowing communication with interacting entities, such as user devices managed by a requester and a data store as described in this document. The PPM 1300 also comprises a second memory 1230 comprising instructions which when executed by the processor 1310 causes the processor 1310 to execute a method or process, such as any one described in this document, such as e.g. issuing RPTs, executing access control decisions at run time, or allowing an owner to create new policies or to edit policies already stored in the first memory 1320. Such instructions may be arranged in one or more interacting modules 1240a-1240n, provide functionality allowing the PPM to act as an AM and PPS, as described herein. More specifically such modules may include at least a GUI for providing data owners with views of hosts, applications and policies defined by the owner, and for allowing the owner to manage such policies, e.g. by revising, deleting, viewing or editing policies, APIs required for allowing the data store 1200 to communicate with a PPM are also typically included. The GUI and APIs may be selected from any known suitable alternative, and the functionality of these are therefore out of the scope of this document. In addition the second memory 1330 may comprise e.g. a redirecting module for redirecting a requester to a PPM, one or more processing modules for processing registration requests or RPT requests received from a requester, or authorization requests received from the data store, to authorization requests received from the PPM. However, other combinations of functional modules may be applied instead as long as the functionality as described in this document can be executed.

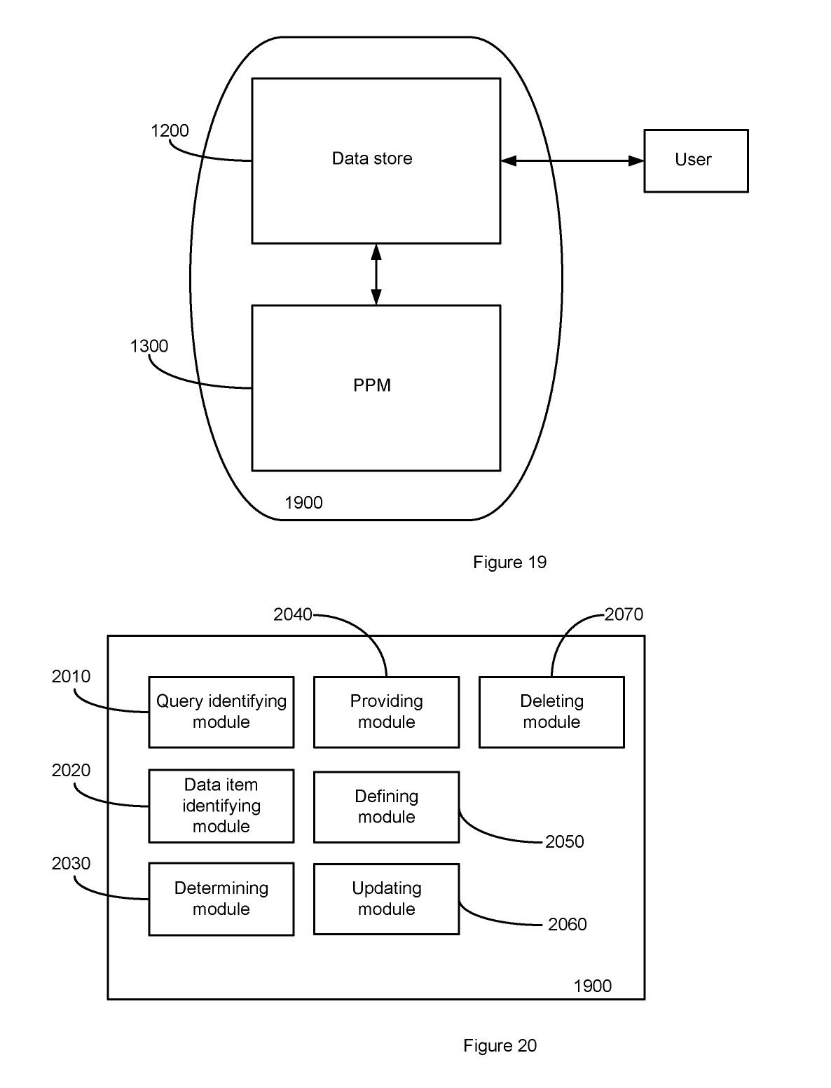

A system 1900 can be defined which comprises at least one data store, which in the present context may alternatively be referred to as at least one PDV, such as the one described above with reference to FIG. 12 and at least one PPM, such as the one described above with reference to FIG. 13. Such a system is illustrated in FIG. 19.

The system of FIG. 19 is capable of protecting resources stored in a data store as suggested above and, comprises at least one processor 1210,1310 and at least one memory 1230,1330 comprising instructions which when executed by the at least one processor 1210,1310 causes the system to protect the different resources on the basis of a policy defined for each of the respective resources and structured in an hierarchical manner, thereby allowing the different resources to be protected with a variable granularity, by defining policies such that the most fine-grained of the policies defined for a specific resource is dynamically applicable for that resource when executing a request involving that resource. While the data store and PPM are presented as separate units in FIG. 19, the system may alternatively be configured as one single physical unit comprising the described functionality.

The system described above may comprise further instructions, which when executed by the at least one processor 1210, 1310 causes the system to apply a policy strategy which define a first policy for a class representing at least one data item, such that the first policy is applied for the mentioned class and its subclasses for which no policy has been defined, wherein for each of said subclasses for which a policy other than the first policy has been defined, such a policy overrides the first policy when executing a request involving at least one of the data items of said class.

As already suggested above, policies may be applied according to one of three possible embodiments. According to one embodiment the system 1900 comprise further instructions which when executed by the at least one processor 1210, 1310 causes the system to define a policy for each resource comprising at least one data item and being a subclass of said class for which no policy has previously been defined, by replicating the content of said first policy to each of said other policies.

According to another embodiment the system 1900 comprise further instructions which when executed by the at least one processor 1210, 1310 causes the system to define a policy, which may be a policy other than the first policy, for each sub-class comprising at least one data item and being a subclass of said class for which no policy has previously been defined, by providing, to the respective policy for each of said subclasses, a reference, referring to said first policy.

According to a third embodiment the system 1900 comprise further instructions which when executed by the at least one processor 1210, 1310 causes the system to define a policy, which may be a policy other than the first policy, by listing each sub-class comprising at least one data item and being a subclass of said class, for which no policy has previously been defined, as a sub-class for which said first policy is to be applied.

Once policies have been defined search can be executed in the system. More specifically, the system 1900 may further comprise instructions, which when executed by the at least one processor 1210, 1310 causes the system to search for resources for which a policy has been defined, by: identifying a query received from a requester; identifying requested data items; determining data items that are accessible to the requester according to relevant policies by matching, for each identified data item, a unique Identity or name associated to a specific policy to stored policies, and providing a response to the requester according to the matching policies.

In order to allow a user to update policies the system 1900 may also comprise further instructions, which when executed by the at least one processor 1210, 1310 causes the system to update a first policy and to update each policy defined for a subclass of said class having the same content as the first policy. In a corresponding manner, policies the system 1900 may also comprise further instructions, which when executed by the at least one processor 1210, 1310 causes the system to delete a first policy which has been defined for a class representing at least one data item and to delete each policy defined for a subclass of said class having the same content as the first policy.

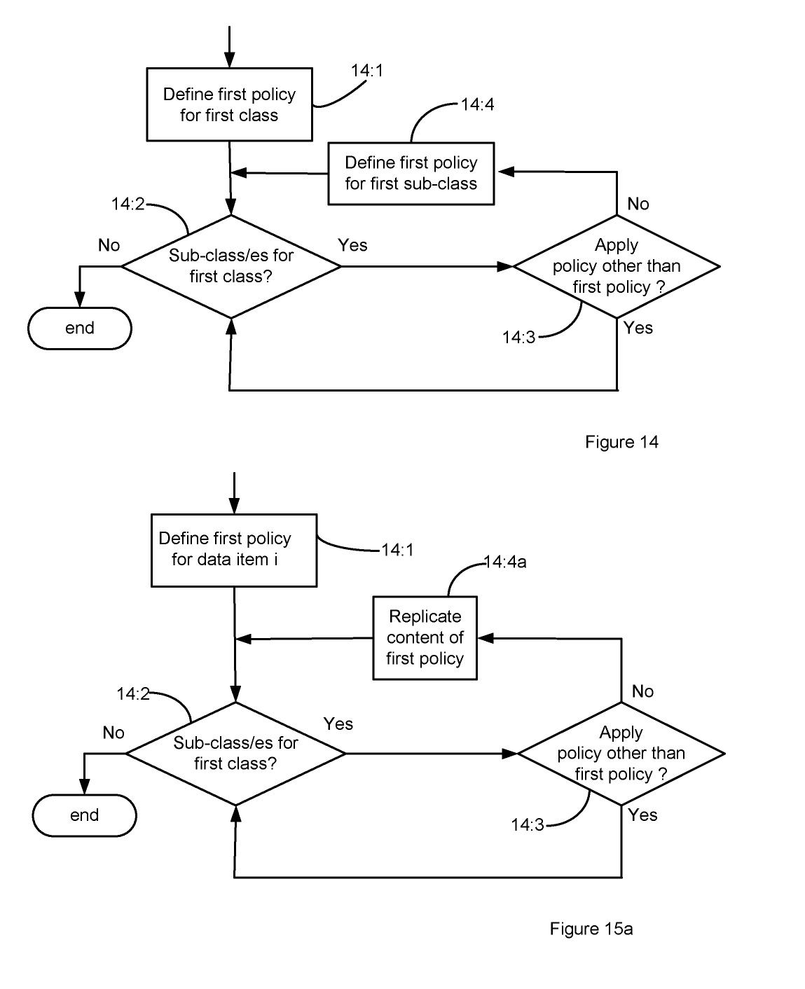

FIG. 20 is an illustration of one possible configuration of the system 1900 described above with reference to FIG. 19, comprising a plurality of interacting modules or units which are capable of interacting, and thereby performing the method steps as suggested above with reference to any of FIG. 11a-c or FIG. 14-18. These modules may be configured as software modules, hardware modules, or as a combination of software and hardware modules or units. More specifically, the query identifying module 2010 is configured to execute method steps 16:1, 17:1 and 18:1 as described herein, the data item identifying module 2020 is configured to execute method steps 16:2, 17:2 and 18:2, the determining module 2030 is configured to execute method steps 1 6:3, 17:3 and 18:3, the providing module 1040m is configured to execute step 16:7, the defining module 2050 is configured to execute steps 14:1, 14:4a-c.

The updating module 2060 is configured to execute step 17:4 and the deleting module 2060 is configured to execute step 18:4.

While the embodiments have been described in terms of several embodiments, it is contemplated that alternatives, modifications, permutations and equivalents thereof will become apparent upon reading of the specifications and study of the drawings. It is therefore intended that the following appended claims include such alternatives, modifications, permutations and equivalents as fall within the scope of the embodiments and defined by the pending claims.

1. A method for protecting resources stored in a data store, the method comprising:
protecting the different resources on the basis of different policies defined for each of the respective resources and structured in a hierarchy; and
protecting the different resources with a variable granularity, by defining policies such that the most fine-grained of the policies defined for a specific resource is dynamically applicable for that resource when executing a request involving that resource.

2. The method according to claim 1 comprising:
defining a first policy for a class representing at least one data item, such that the first policy is applied for said class and each subclass of said class for which no policy has been defined,
wherein for each of said subclasses for which a policy other than the first policy has been defined, such a policy overrides said first policy when executing a request involving at least one of the data items of said sub-classes.

3. The method according to claim 1, wherein defining a policy to be applied for at least one data item represented by a class includes associating said policy with a unique identity or name, where each unique identity or name identifies one of said data items or said class, thereby making the policy identifiable.

4. The method according to claim 2, comprising the further step of:
defining a policy, which may be a policy other than the first policy, for each sub-class comprising at least one data item and being a subclass of said class for which no policy has previously been defined, by replicating the content of said first policy to each of said other policies.

5. The method according to claim 2, comprising the further step of:
defining a policy, which may be a policy other than the first policy, for each sub-class comprising at least one data item and being a subclass of said class for which no policy has previously been defined, by providing, to the respective policy for each of said subclasses, a reference, referring to said first policy.

6. The method according to claim 2, comprising the further step of:
defining a policy, which may be a policy other than the first policy, by listing each sub-class comprising at least one data item and being a subclass of said class, for which no policy has previously been defined, as a sub-class for which said first policy is to be applied.

7. The method for searching for resources for which a policy has been defined according to claim 1, wherein the searching is executed by:
identifying a query received from a requester;
identifying requested data items;
determining data items that are accessible to the requester according to relevant policies by matching, for each identified data item, a unique Identity or name associated to a specific policy to stored policies, and
providing a response to the requester according to the matching policies.

8. The method according to claim 1 further comprising:
updating each policy defined for a subclass of a class having the same content as a first policy which has been defined for a class representing at least one data item.

9. The method according to claim 1 further comprising:
deleting each policy defined for a subclass of a class having the same content as a first policy which has been defined for a class representing at least one data item.

10. A computer program product comprising a non-transitory computer readable storage medium storing instructions which when executed on at least one processor causes the at least one processor to carry out the method according to claim 1.

11. A system configured to protect resources stored in a data store, the system comprising:
at least one processor; and
at least one memory comprising instructions which when executed by the at least one processor causes the system to:
protect the different resources on the basis of a policy defined for each of the respective resources and structured in a hierarchy; and
protect the different resources with a variable granularity, by defining policies such that the most fine-grained of the policies defined for a specific resource is dynamically applicable for that resource when executing a request involving that resource.

12. The system according to claim 11, comprising further instructions, which when executed by the at least one processor causes the system to:
define a first policy for a class, such that the first policy is applied for a class representing at least one data item, said class and each sub-class for which no policy has been defined,
wherein for each of said subclasses for which a policy other than the first policy has been defined, such a policy overrides said first policy when executing a request involving at least one of the data items of said sub-classes.

13. The system according to claim 11, comprising further instructions, which when executed by the at least one processor causes the system to:
define a policy, which may be a policy other than the first policy, to be applied for each sub-class comprising at least one data item represented by a class by associating said policy with a unique identity or name, where each unique identity or name identifies one of said data items or said class, thereby making the policy identifiable.

14. The system according to claim 11, comprising further instructions, which when executed by the at least one processor causes the system to:
define a policy, which may be a policy other than the first policy, for each sub-class comprising at least one data item and being a subclass of said class for which no policy has previously been defined, by replicating the content of said first policy to each of said other policies.

15. The system according to claim 11, comprising further instructions, which when executed by the at least one processor causes the system to:
define a policy, which may be a policy other than the first policy, for each sub-class comprising at least one data item and being a subclass of said class for which no policy has previously been defined, by providing, to the respective policy for each of said subclasses, a reference, referring to said first policy.

16. The system according to claim 11, comprising further instructions, which when executed by the at least one processor causes the system to:
define a policy, which may be a policy other than the first policy, by listing each sub-class comprising at least one data item and being a subclass of said class, for which no policy has previously been defined, as a resource for which said first policy is to be applied.

17. The system according to claim 11, comprising further instructions, which when executed by the at least one processor causes the system to search for resources for which a policy has been defined, by:
identifying a query received from a requester;
identifying requested data items;
determining data items that are accessible to the requester according to relevant policies by matching, for each identified data item, a unique Identity or name associated to a specific policy to stored policies, and
providing a response to the requester according to the matching policies.

18. The system according to claim 11, comprising further instructions, which when executed by the at least one processor causes the system to update a first policy which has been defined for a class representing at least one data item and to:
update each policy defined for a subclass of said class having the same content as the first policy.

19. The system according to claim 11, comprising further instructions, which when executed by the at least one processor causes the system to delete a first policy which has been defined for a class representing at least one data item and to:
delete each policy defined for a subclass of said class having the same content as the first policy.
